(19) United States
(12) Patent Application Publication
(10) Pub. No.: US 2014/0375624 A1
(43) Pub. Date: Dec. 25, 2014

(54) IMAGE PROCESSING DEVICE, IMAGE DISPLAY DEVICE AND IMAGE PROCESSING METHOD

(71) Applicant: Kabushiki Kaisha Toshiba, Tokyo (JP)

(72) Inventor: Takashi Kanoh, Yokohama-Shi (JP)

(73) Assignee: KABUSHIKI KAISHA TOSHIBA, Tokyo (JP)

(21) Appl. No.: 14/103,345

(22) Filed: Dec. 11, 2013

(30) Foreign Application Priority Data
Jun. 21, 2013 (JP) 2013-130948

(51) Int. Cl. G09G 5/18

(52) U.S. Cl. CPC G09G 5/18
USPC 345/213

(57) ABSTRACT

According to an embodiment, an image processing device is operable by switching an operation mode among a first mode and a second mode. In the first mode, a first synchronization signal and a first image signal are inputted. The first synchronization signal comprising pulses having a first cycle, and the first image signal is composed of a plurality of frames switching in synchronization with the pulses of the first synchronization signal. In the second mode, an input of the first synchronization signal and the first image signal is stopped and a second image signal written to a frame memory is read.

### CROSS-REFERENCE TO RELATED APPLICATIONS

This application is based upon and claims the benefit of priority from the prior Japanese Patent Application No. 2013-130948, filed on Jun. 21, 2013, the entire contents of which are incorporated herein by reference.

### FIELD

Embodiments described herein relate generally to an image processing device, an image display device and an image processing method.

### BACKGROUND

In recent years, in mobile devices having a display function, such as smartphones and tablets, in particular, reducing power for the display function is a major challenge. Therefore, switching a display manner between a still image and a moving image is performed.

For example, it is proposed that when displaying a moving image, an image signal of the moving image is transmitted from a processor, and when displaying a still image, an image signal of the still image is stored in a frame memory and then the still image is displayed. Thereby, it is possible to stop the processor when displaying a still image, so that the power consumption can be reduced.

However, a still image is switched to a moving image at any timing. Therefore, there is a problem that a displayed image is degraded unless the switching from the still image to the moving image is appropriately performed.

### BRIEF DESCRIPTION OF THE DRAWINGS

FIG. 1 is a block diagram showing a schematic configuration of an image display device according to an embodiment.

FIG. 2 is a timing chart for illustrating processing operations of the application processor 1 and the image processing device 2 when switching from the bypass mode to the SR mode.

FIG. 3 is a sequence diagram showing an example of processing operations of the application processor 1 and the image processing device 2 when switching from the bypass mode to the SR mode.

FIG. 4 is a timing chart for illustrating processing operations of the application processor 1 and the image processing device 2 when switching from the SR mode to the bypass mode.

FIG. 5 is a sequence diagram showing an example of processing operations of the application processor 1 and the image processing device 2 when switching from the SR mode to the bypass mode.

FIG. 6 is a timing chart for illustrating processing operations of the application processor 1 and the image processing device 2 when the displayed still image is switched in the SR mode.

### DETAILED DESCRIPTION

According to an embodiment, an image processing device is operable by switching an operation mode among a first mode and a second mode. In the first mode, a first synchronization signal and a first image signal are inputted. The first synchronization signal comprising pulses having a first cycle, and the first image signal is composed of a plurality of frames switching in synchronization with the pulses of the first synchronization signal. In the second mode, an input of the first synchronization signal and the first image signal is stopped and a second image signal written to a frame memory is read.

The image processing device includes a synchronization controller, a writing controller, a reading controller and a selector.

The synchronization controller is configured to generate a second synchronization signal based on the first synchronization signal, the synchronization controller generating pulses of the second synchronization signal, when the operation mode is switched from the second mode to the first mode, after a period of time equal to or longer than the first cycle has elapsed from the switching.

The writing controller is configured to write the first image signal to the frame memory. The reading controller is configured to read the first image signal written to the frame memory as the second image signal in synchronization with the pulses of the second synchronization signal.

The selector is configured to select the second image signal in the second mode and to select the first image signal after at least second frame of the first image signal inputted immediately after the switching of the operation mode from the second mode to the first mode.

Hereinafter, embodiments will be described in detail.

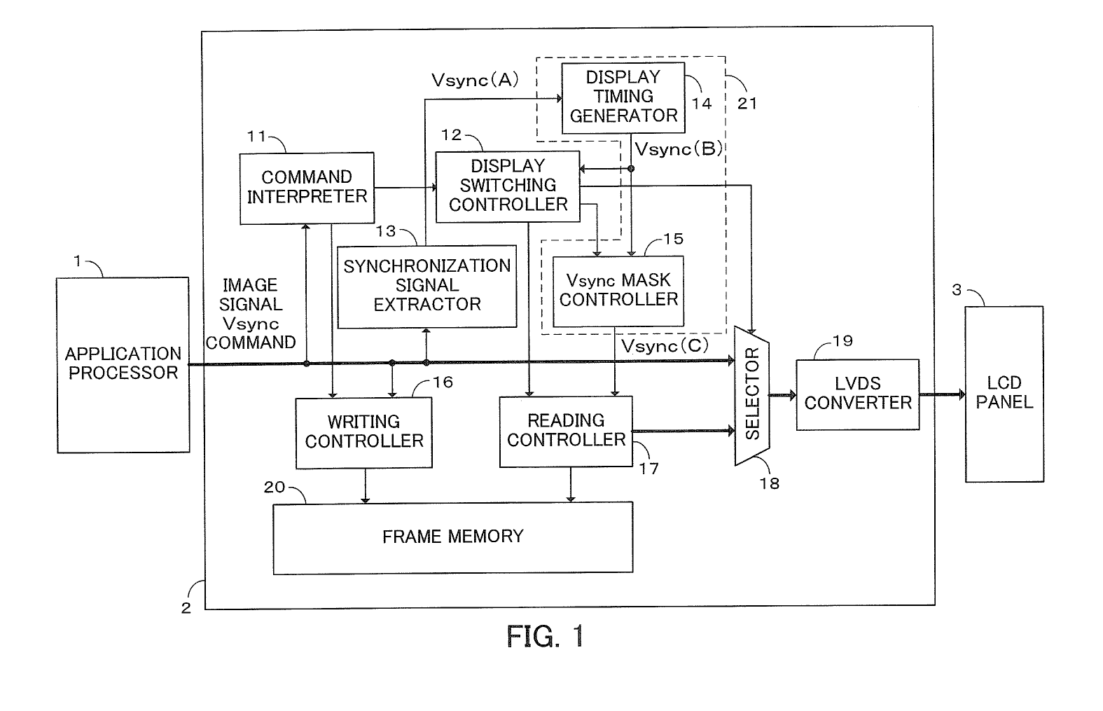

FIG. 1 is a block diagram showing a schematic configuration of an image display device according to an embodiment. The image display device includes an application processor 1, an image processing device 2, and an LCD panel (display unit) 3.

The application processor 1 generates an image signal (first image signal) representing an image to be displayed on the LCD panel 3 and a vertical synchronization signal Vsync (first synchronization signal). The image signal includes a plurality of frames. The vertical synchronization signal Vsync includes a pulse indicating a switching timing of a frame. In other words, a frame displayed on the LCD panel 3 is switched in synchronization with the pulse of the vertical synchronization signal Vsync. The cycle of the vertical synchronization signal Vsync is, for example, 1/30 second, that is, the frame rate of the image signal is 30 frames per second (fps).

The application processor 1 transmits the image signal and the vertical synchronization signal Vsync to the image processing device 2. In the present embodiment, it is assumed that an output interface of the application processor 1 is display serial interface (DSI) and the application processor 1 can transmit not only the image signal and the vertical synchronization signal Vsync, but also various commands to the image processing device 2.

The image processing device 2 processes the image signal and transmits the image signal to the LCD panel 3. In the present embodiment, it is assumed that an input interface of the LCD panel 3 is low voltage differential signaling (LVDS). In this way, the output interface of the application processor 1 and the input interface of the LCD panel 3 may be different from each other. In such a case, the image processing device 2 performs a process to convert an output format of the application processor 1 into an input format of the LCD panel 3.

The LCD panel 3 displays an image according to the received image signal. The LCD panel 3 is a hold-type display and can hold an image for a time longer than the cycle of the vertical synchronization signal Vsync, preferably for a time of about two cycles of the Vsync. Another hold-type display such as an organic Electro-Luminescence (EL) panel may be used instead of the LCD panel 3.

Next, the image processing device 2 will be described in detail. The image processing device 2 is set to either one of a bypass mode (first mode) or a self refreshment (SR) mode (second mode) according to a command from the application processor 1 and performs an operation according to the mode.

The bypass mode is, for example, a mode for displaying a moving image. In the case of the bypass mode, the image processing device 2 transmits an image signal received from the application processor 1 to the LCD panel 3.

The SR mode is, for example, a mode for displaying a still image. In the case of the SR mode, the image processing device 2 temporarily writes an image signal received from the application processor 1 to a frame memory 20. Thereafter, the image processing device 2 reads the image signal from the frame memory 20 and transmits the image signal to the LCD panel 3. In the SR mode, after the image signal is written to the frame memory 20, it is possible to stop the transmission of the image signal from the application processor 1, so that the power consumption of the entire image display device can be suppressed.

As shown in FIG. 1, the image processing device 2 includes a command interpreter 11, a display switching controller 12, a synchronization signal extractor 13, a display timing generator 14, a Vsync mask controller (synchronization mask controller) 15, a writing controller 16, a reading controller 17, a selector 18, a LVDS converter 19, and the frame memory 20. The frame memory 20 may be located outside the image processing device 2 as an external memory.

The command interpreter 11 interprets a command received from the application processor 1. The command includes, for example, an update command UD, a self-refresh command SR and a bypass command BP. The update command UD indicates to write the image signal from the application processor 1 to the frame memory 20. The self-refresh command SR indicates to switch the mode from the bypass mode to the SR mode. The bypass command BP indicates to switch the mode from the SR mode to the bypass mode. Each command obtained by the command interpretation is transmitted to the display switching controller 12. Further, the command interpreter 11 supplies a writing start signal to the writing controller 16 according to the update command UD.

The display switching controller 12 controls the Vsync mask controller 15, the reading controller 17, and the selector 18 according to the command. More specifically, the display switching controller 12 supplies a mask control signal to the Vsync mask controller 15 according to the bypass command BR Further, the display switching controller 12 supplies a reading start signal and a reading stop signal to the reading controller 17 according to the self-refresh command SR and the bypass command BP, respectively. Further, the display switching controller 12 supplies a selection control signal to the selector 18 according to the self-refresh command SR and the bypass command BP, the selection control signal is indicating an image signal to be selected by the selector 18.

The synchronization signal extractor 13 extracts the vertical synchronization signal Vsync from signals received from the application processor 1. In the description below, the vertical synchronization signal extracted by the synchronization signal extractor 13 is represented as Vsync (A) in comparison with the vertical synchronization signal Vsync received from the application processor 1. The extracted vertical synchronization signal Vsync (A) is supplied to the display timing generator 14.

The display timing generator 14 generates a vertical synchronization signal Vsync (B) (third synchronization signal) from the vertical synchronization signal Vsync (A). In other words, when the vertical synchronization signal Vsync (A) is supplied to the display timing generator 14 from the synchronization signal extractor 13, the display timing generator 14 outputs the vertical synchronization signal Vsync (B) in synchronization with the vertical synchronization signal Vsync (A), more specifically, outputs the vertical synchronization signal Vsync (B) which is the same as the vertical synchronization signal Vsync (A). When the supply of the vertical synchronization signal Vsync (A) to the display timing generator 14 is stopped, the display timing generator 14 outputs the vertical synchronization signal Vsync (B) at the same cycle as that of the vertical synchronization signal Vsync (A) that has been supplied so far. Thereafter, if the vertical synchronization signal Vsync (A) is supplied to the display timing generator 14 from the synchronization signal extractor 13, the display timing generator 14 outputs the vertical synchronization signal Vsync (B) which is the same as the vertical synchronization signal Vsync (A). The vertical synchronization signal Vsync (B) is supplied to the Vsync mask controller 15 and the display switching controller 12.

The Vsync mask controller 15 masks a part of pulses of the vertical synchronization signal Vsync (B) according to the mask control signal from the display switching controller 12 and outputs a vertical synchronization signal Vsync (C) (second synchronization signal).

The display timing generator 14 and the Vsync mask controller 15 forms a synchronization controller 21.

The writing controller 16 writes one frame of the image signal from the application processor 1 to the frame memory 20 according to the writing start signal from the command interpreter 11. The writing controller 16 may compress the image signal and write the compressed image signal to the frame memory 20.

The reading controller 17 reads the image signal written to the frame memory 20 in synchronization with the vertical synchronization signal Vsync (C) from the Vsync mask controller 15 according to the reading start signal from the display switching controller 12. When a compressed image signal is written, the reading controller 17 performs expansion processing when reading the image signal. The reading controller 17 stops reading the image signal according to the reading stop signal from the display switching controller 12.

The selector 18 selects and outputs either the image signal from the application processor 1 (first image signal) or the image signal read from the frame memory 20 (second image signal) according to the selection control signal from the display switching controller 12. More specifically, the selector 18 selects the image signal from the application processor 1 in the bypass mode and selects the image signal read from the frame memory 20 in the SR mode.

The LVDS converter 19 converts the image signal outputted from the selector 18 into an LVDS format and supplies the converted image signal to the LCD panel 3.

As described above, in the bypass mode, the image processing device 2 transmits the image signal from the application processor 1 to the LCD panel 3. On the other hand, in the SR mode, the image processing device 2 reads the image signal from the frame memory 20 and transmits the image signal to the LCD panel 3.

Next, a processing operation of the image display device when switching between the SR mode and the bypass mode or when switching still images in the SR mode will be described.

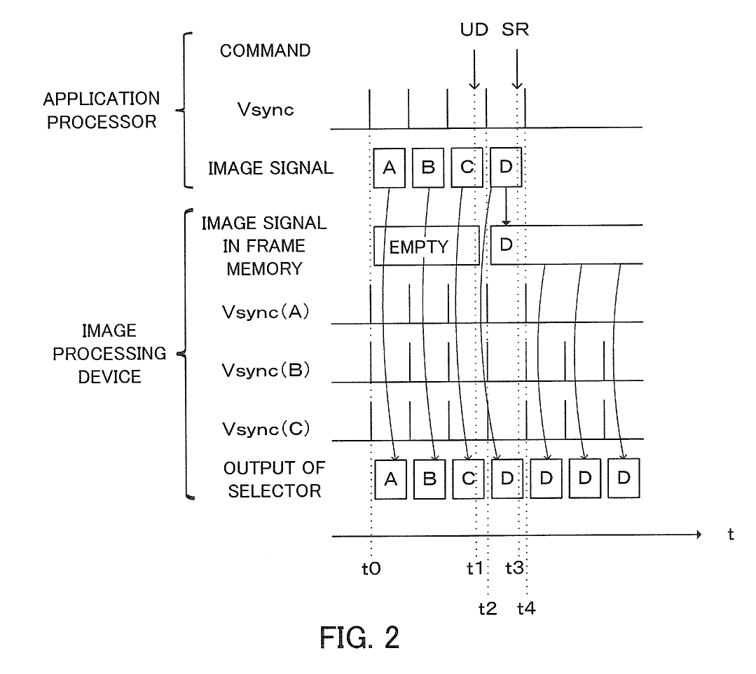

First, the switching from the bypass mode to the SR mode will be described. FIG. 2 is a timing chart for illustrating processing operations of the application processor 1 and the image processing device 2 when switching from the bypass mode to the SR mode. FIG. 2 schematically shows, from above, a command, the vertical synchronization signal Vsync, and the image signal, which are transmitted from the application processor 1 to the image processing device 2, and the image signal written to the frame memory 20, the vertical synchronization signals Vsync (A), Vsync (B), and Vsync (C), and the image signal outputted from the selector 18 in the image processing device 2.

The pulses of the vertical synchronization signal Vsync (A) in FIG. 2 represent the frame switching timing of the image signal. In FIG. 2, signal transmission delays between each component are ignored.

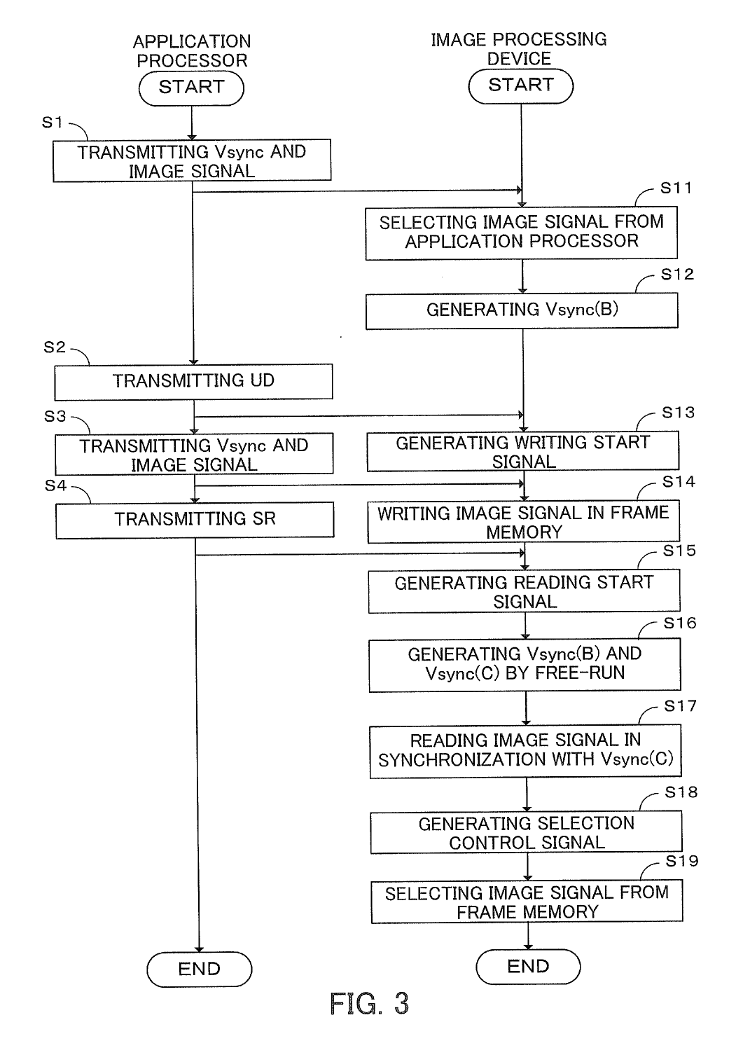

FIG. 3 is a sequence diagram showing an example of processing operations of the application processor 1 and the image processing device 2 when switching from the bypass mode to the SR mode.

In the bypass mode, the application processor 1 transmits the vertical synchronization signal Vsync and the image signal to the image processing device 2 (step S1). The selector 18 of the image processing device 2 selects the image signal from the application processor 1 (step S11). For example, at time t0, the selector 18 selects the frame A of the image signal outputted from the application processor 1.

In the bypass mode, the synchronization signal extractor 13 extracts the vertical synchronization signal Vsync from the application processor 1 and generates the vertical synchronization signal Vsync (A). The display timing generator 14 generates the vertical synchronization signal Vsync (B) synchronized with the vertical synchronization signal Vsync (A) (step S12). Of course, the cycle of the vertical synchronization signal Vsync (B) is the same as that of the vertical synchronization signals Vsync and Vsync (A).

The image processing device 2 operates in the bypass mode until receiving the update command UD. In the bypass mode, the writing controller 16, the reading controller 17, and the Vsync mask controller 15 need not operate.

When switching from the bypass mode to the SR mode, the application processor 1 sequentially transmits

the update command UD (time t1 in FIG. 2, step S2 in FIG. 3),

the vertical synchronization signal Vsync and the image signal D for a still image (time t2 in FIG. 2, step S3 in FIG. 3), and

the self-refresh command SR (time t3 in FIG. 2, step S4 in FIG. 3)

to the image processing device 2.

After transmitting the self-refresh command SR, the application processor 1 may further transmit one or more vertical synchronization signals Vsync (time t4 in FIG. 2). However, thereafter, the application processor 1 stops the transmission of the vertical synchronization signal Vsync and the image signal.

At time t1 in FIG. 2, when the command interpreter 11 of the image processing device 2 receives the update command UD, the command interpreter 11 generates the writing start signal and supplies the writing start signal to the writing controller 16 (step S13).

At time t2 in FIG. 2, the writing controller 16 of the image processing device 2 receives the frame D for a still image from the application processor 1. Then, the writing controller 16 writes the frame D for a still image to the frame memory 20 according to the writing start signal (step S14). While the writing controller 16 is writing the frame D to the frame memory 20, the selector 18 selects the frame D from the application processor 1. The writing of the frame D is completed from time t2 to time t4.

At time t3 in FIG. 2, when the command interpreter 11 of the image processing device 2 receives the self-refresh command SR, the display switching controller 12 generates the reading start signal and supplies the reading start signal to the reading controller 17 (step S15).

After the time t4 in FIG. 2, the vertical synchronization signal Vsync is not supplied from the application processor 1, so that the synchronization signal extractor 13 does not output the vertical synchronization signal Vsync (A). However, the display timing generator 14 continuously generates the vertical synchronization signal Vsync (B) by free-run at the same cycle as that of the vertical synchronization signal Vsync (A) that has been extracted so far. The Vsync mask controller 15 outputs the vertical synchronization signal Vsync (B) itself as the vertical synchronization signal Vsync (C) (step S16).

The reading controller 17 reads the frame D written to the frame memory 20 in synchronization with a pulse of the vertical synchronization signal Vsync (C) according to the reading start signal.

On the other hand, at time t3, the command interpreter 11 of the image processing device 2 receives the self-refresh command SR. The display switching controller 12 generates a selection control signal in synchronization with the vertical synchronization signal Vsync (B) at time t4 thereafter and transmits the selection control signal to the selector 18 (step S18). Thereby, the selector 18 selects the frame D read by the reading controller 17 instead of the image signal from the application processor 1 (step S19).

In this way, after the time t4, the image signal D written to the frame memory 20 is outputted from the selector 18 and the switching from the bypass mode to the SR mode is completed.

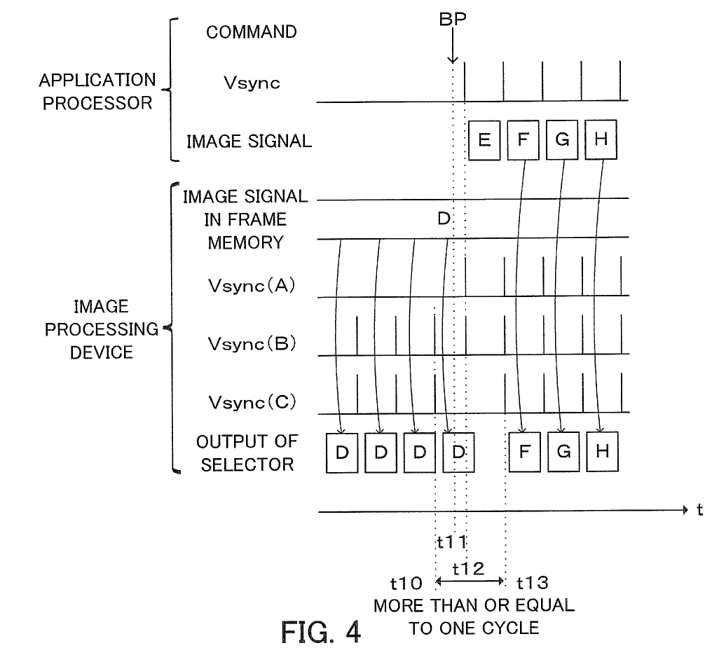

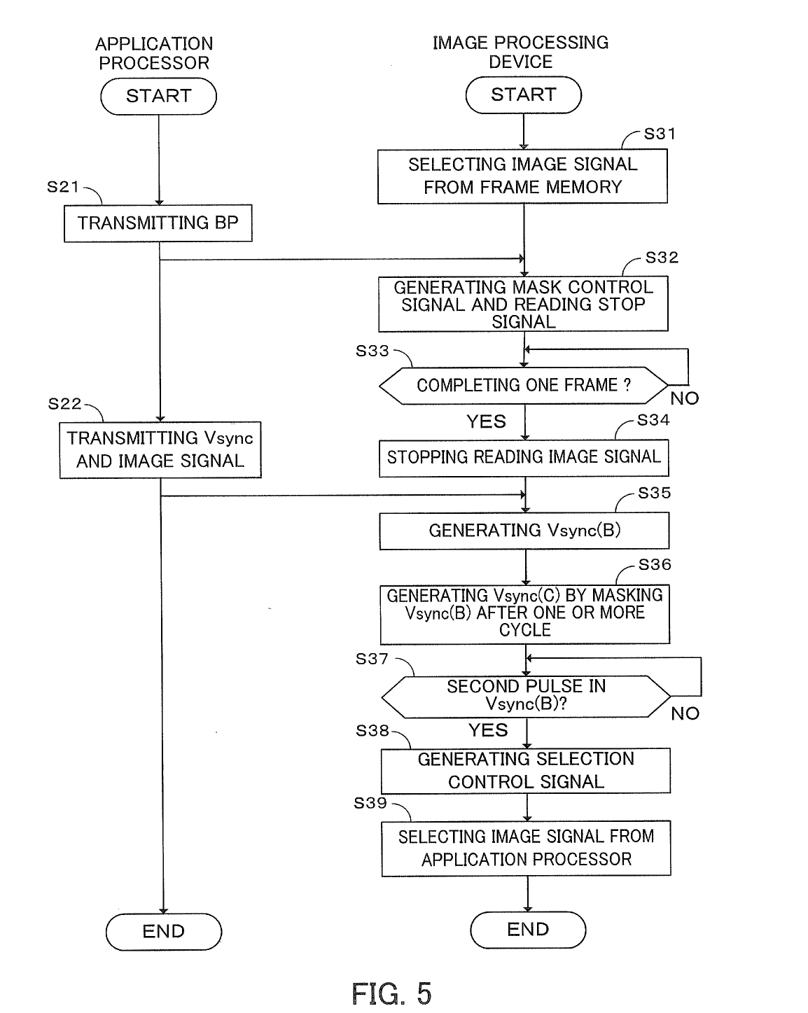

Next, the switching from the SR mode to the bypass mode will be described. FIG. 4 is a timing chart for illustrating processing operations of the application processor 1 and the image processing device 2 when switching from the SR mode to the bypass mode. FIG. 4 shows an example in which the frame D has already been written to the frame memory 20. FIG. 5 is a sequence diagram showing an example of processing operations of the application processor 1 and the image processing device 2 when switching from the SR mode to the bypass mode.

As described above, in the SR mode, the image signal is not transmitted from the application processor 1 to the image processing device 2. The reading controller 17 of the image processing device 2 reads the image signal from the frame memory 20 and the selector 18 selects the read image signal (step S31).

When switching from the SR mode to the bypass mode, the application processor 1 sequentially transmits

the bypass command BP (time t11 in FIG. 4, step S21 in FIG. 5) and

the vertical synchronization signal Vsync and the image signal formed by the frames E, F, . . . for a moving image (time t12 in FIG. 2, step S22 in FIG. 5)

to the image processing device 2.

Here, the operation mode can be switched from the SR mode to the bypass mode at any timing, so that the vertical synchronization signal Vsync transmitted to the image processing device 2 is not necessarily in synchronization with the vertical synchronization signals Vsync (B) and Vsync (C) in the image processing device 2. However, the cycle of the vertical synchronization signal Vsync that is newly transmitted to the image processing device 2 in the bypass mode is the same as that of the vertical synchronization signals Vsync (B) and Vsync (C) in the image processing device 2.

At time t11 in FIG. 4, when the command interpreter 11 of the image processing device 2 receives the bypass command BP, the display switching controller 12 generates the mask control signal to supply it to the Vsync mask controller 15 and generates the reading stop signal to supply it to the reading controller 17 (step S32).

Even when the reading stop signal is generated, the reading controller 17 does not immediately stop the reading of the frame D and continuously reads the frame D until the reading of the frame D that is currently being read is completed (step S33: YES). After the reading of one frame is completed, even if a pulse of the vertical synchronization signal Vsync (C) is generated, the reading controller 17 does not read the frame D stored in the frame memory 20 (step S34).

On the other hand, after the time t12 in FIG. 4, the vertical synchronization signal Vsync is transmitted from the application processor 1 to the image processing device 2. The synchronization signal extractor 13 extracts the vertical synchronization signal Vsync from the application processor 1 and generates the vertical synchronization signal Vsync (A). Although the display timing generator 14 generates the vertical synchronization signal Vsync (B) by free-run in the SR mode, the display timing generator 14 generates the vertical synchronization signal Vsync (B) in synchronization with the vertical synchronization signal Vsync (A) from the synchronization signal extractor 13 after the time t12 (step S35).

Here, the vertical synchronization signal Vsync is inputted from the application processor 1 at any timing (time t12 in FIG. 4, step S22 in FIG. 5). Therefore, as shown in FIG. 4, the intervals of the pulses of the vertical synchronization signal Vsync (B) are even before time t10, however, the time interval between the pulse at time t10 and the pulse at time t12 may be shorter than one cycle

Therefore, when the mask control signal is supplied to the Vsync mask controller 15 at time t11, the Vsync mask controller 15 masks the pulse of the vertical synchronization signal Vsync (B) immediately after the time t11 (that is, the pulse at time t12) and outputs the vertical synchronization signal Vsync (C) in which the second and the following pulses are reflected. As a result, the pulse of the vertical synchronization signal Vsync (C) is generated (at time t13) after a period of time longer than or equal to one cycle has elapsed from the pulse (at time t10) of the vertical synchronization signal Vsync (C) immediately before the bypass command BP is issued (step S36).

The display switching controller 12 generates a selection control signal in synchronization with the second pulse (at time t13) after the bypass command BP of the vertical synchronization signal Vsync (B) is received (step S37: YES) and supplies it to the selector 18 (step S38). Responding to the selection control signal, the selector 18 selects the frame F from the application processor 1 instead of the frame D read by the reading controller 17 (step S39). As a result, among the image signals received by the image processing device 2, the frame E which is the first frame immediately after the bypass command BP is not selected by the selector 18 and is not displayed. The frame F, which is the second frame after the first frame E, and the following frames are selected by the selector 18 and displayed.

As described above, as one of the features of the present embodiment, when the operation mode is switched from the SR mode to the bypass mode, at most two cycles of the vertical synchronization signal Vsync (C) vary by the mask processing of the Vsync mask controller 15. In other words, the pulse (at time t13) of the vertical synchronization signal Vsync (C) is generated after a period of time longer than or equal to one cycle has elapsed from the last pulse (at time t10) of the vertical synchronization signal Vsync (C) in the SR mode.

If the mask processing is not performed, a pulse of the vertical synchronization signal Vsync (C) is generated at time t12 after a period of time shorter than one cycle has elapsed from the last pulse (at time t10) of the vertical synchronization signal Vsync (C) in the SR mode. If two pulses are generated in the vertical synchronization signal Vsync in a period of time shorter than normal one cycle in this way, there is a risk that the LCD panel 3 does not operate normally. Further, if the reading controller 17 reads the image signal in synchronization with the pulse of the vertical synchronization signal Vsync (C) at time t12, a display of a frame is started in the middle of another frame, so that the image displayed on the LCD panel 3 is destroyed.

On the other hand, in the present embodiment, a pulse of the vertical synchronization signal Vsync (C) is generated at time t13 after a period of time longer than or equal to one cycle of the vertical synchronization signal Vsync (C) has elapsed from the last pulse (at time t10) of the vertical synchronization signal Vsync (C) in the SR mode. Since the LCD panel 3 is a hold-type display, even if the vertical synchronization signal is not inputted for one cycle or more, the LCD panel 3 can display the currently displayed image. Therefore, it is possible to prevent malfunction of the LCD panel 3. Further, it is possible to display a correct image on the LCD panel 3.

Further, as another feature of the present embodiment, when the SR mode is switched to the bypass mode, among the image signals from the application processor 1, the first frame immediately after the bypass command BP is not selected. In other words, the image signal selected by the selector 18 is switched (at time t13) after a period of time longer than or equal to one cycle has elapsed from the last pulse (at time t10) of the vertical synchronization signal Vsync (C) in the SR mode.

It is assumed that the image signal selected by the selector 18 is switched immediately after the bypass command BR In this case, the frame D read from the frame memory 20 is halfway selected by the selector 18 and thereafter the frame E from the application processor 1 is selected. In this case, the image displayed on the LCD panel 3 is destroyed.

On the other hand, in the present embodiment, the image signal selected by the selector 18 is switched at time t13 after a period of time longer than or equal to one cycle has elapsed from the last pulse (at time t10) of the vertical synchronization signal Vsync (C) in the SR mode. Therefore, it is possible to display a correct image on the LCD panel 3.

Next, switching of a displayed still image (switching from a still image 1 to a still image 2) in the SR mode will be described. To switch the still image, first, the self-refresh mode is switched to the bypass mode, and thereafter, an image from the application processor 1 is written to the frame memory 20 by the update command UD. Next, the bypass mode is switched to the self-refresh mode. Thus, the switching of the still image is a combination of the two switching manners described above, so that the explanation will be simplified.

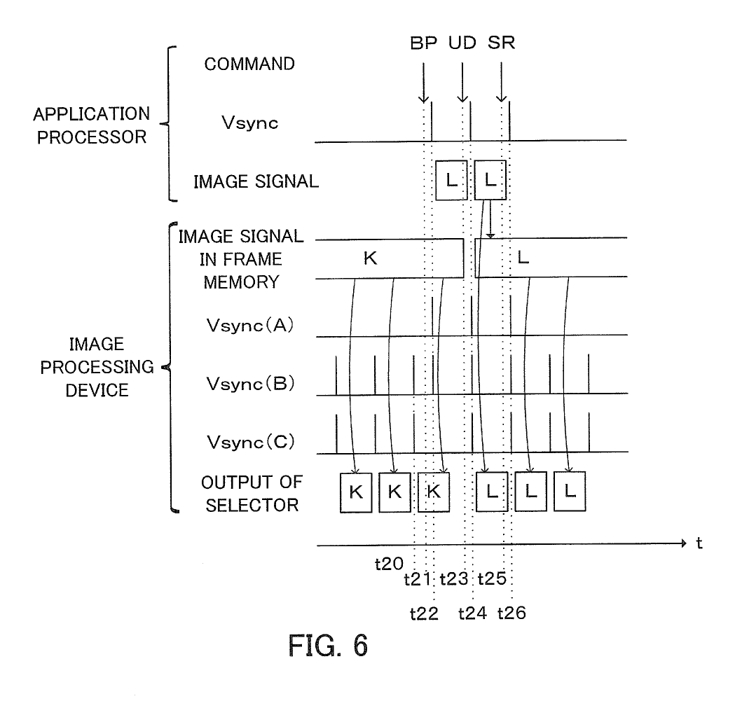

FIG. 6 is a timing chart for illustrating processing operations of the application processor 1 and the image processing device 2 when the displayed still image is switched in the SR mode.

When switching the displayed still image in the SR mode, the application processor 1 sequentially transmits

the bypass command BP (at time t21),

the vertical synchronization signal Vsync and the image signal for a still image after the switching (at time t22),

the update command UD (at time t23),

the vertical synchronization signal Vsync and the image signal for a still image after the switching (at time t24), and

the self-refresh command SR (at time t25)

to the image processing device 2.

When the image processing device 2 receives the bypass command BP (at time t21), as described in FIGS. 4 and 5, the image processing device 2 generates a pulse of the vertical synchronization signal Vsync (C) (at time t24) after a period of time longer than or equal to one cycle has elapsed from the last pulse (at time t20) of the vertical synchronization signal Vsync (C) in the SR mode. Further, the image processing device 2 switches the image signal selected by the selector 18 to the image signal from the application processor 1 (at time t24) after a period of time longer than or equal to one cycle has elapsed from the last pulse (at time t20) of the vertical synchronization signal Vsync (C) in the SR mode. Therefore, at time t24, the frame L from the application processor 1 is selected by the selector 18.

When the image processing device 2 receives the update command UD (at time t23), as described in FIGS. 2 and 3, the writing controller 16 writes the image signal L received at time t24 to the frame memory 20.

Further, when the image processing device 2 receives the self-refresh command SR (at time t25), the reading controller 17 reads the frame L written to the frame memory 20. Further, the image processing device 2 switches the image signal selected by the selector 18 to the image signal L from the frame memory 20.

As can be known from the above description, the image corresponding to the frame L received at time t22 is not displayed, but the image corresponding to the frame K stored in the frame memory 20 is displayed. Therefore, at time t22, the application processor 1 does not necessarily have to transmit the frame L representing an image to be displayed. In other words, the application processor 1 may transmit one frame of any image signal after the bypass command BP and then transmit an image signal representing a still image to be displayed.

In this way, in the present embodiment, the image display device can operate by switching between the bypass mode in which a moving image is displayed by using the image signal from the application processor 1 and the SR mode in which a still image is displayed by using the image signal read from the frame memory 20. The application processor 1 can be stopped when a still image is displayed and the frame memory 20 does not need to be accessed when a moving image is displayed, so that it is possible to reduce the power consumption of the image display device.

When the SR mode is switched to the bypass mode, a pulse of the vertical synchronization signal Vsync (C) is generated after a period of time longer than or equal to one cycle of the vertical synchronization signal Vsync (C) has elapsed from the last pulse of the vertical synchronization signal Vsync (C) in the SR mode. Therefore, it is possible to prevent malfunction of the LCD panel 3 and display a correct image on the LCD panel 3.

When the SR mode is switched to the bypass mode, among the image signals from the application processor 1, the first frame immediately after the switching is not selected. Therefore, it is possible to display a correct image on the LCD panel 3.

In the present embodiment, an example is described in which when the SR mode is switched to the bypass mode, a pulse of the vertical synchronization signal Vsync (C) is generated after a period of time longer than or equal to one cycle and shorter than two cycles of the vertical synchronization signal Vsync (C) has elapsed from the last pulse of the vertical synchronization signal Vsync (C) in the SR mode. However, if the LCD panel 3 can hold an image for two or more cycles, the pulse of the vertical synchronization signal Vsync (C) may be generated after a period of time longer than or equal to two cycles has elapsed. In this case, among the image signals from the application processor 1, two or more frames immediately after the switching are not selected.

At least a part of the image display device explained in the above embodiments can be formed of hardware or software. When the image display device is partially formed of the software, it is possible to store a program implementing at least a partial function of the image display device in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the image display device can be distributed through a communication line (including radio communication) such as the Internet etc. Furthermore, the program which is encrypted, modulated, or compressed can be distributed through a wired line or a radio link such as the Internet etc. or through the recording medium storing the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. An image processing device operable by switching an operation mode among a first mode and a second mode,
wherein in the first mode, a first synchronization signal and a first image signal are inputted, the first synchronization signal comprising pulses having a first cycle, the first image signal being composed of a plurality of frames switching in synchronization with the pulses of the first synchronization signal, and
in the second mode, an input of the first synchronization signal and the first image signal is stopped and a second image signal written to a frame memory is read,
the image processing device comprises:
a synchronization controller configured to generate a second synchronization signal based on the first synchronization signal, the synchronization controller generating pulses of the second synchronization signal, when the operation mode is switched from the second mode to the first mode, after a period of time equal to or longer than the first cycle has elapsed from the switching;
a writing controller configured to write the first image signal to the frame memory;
a reading controller configured to read the first image signal written to the frame memory as the second image signal in synchronization with the pulses of the second synchronization signal; and
a selector configured to select the second image signal in the second mode and to select the first image signal after at least second frame of the first image signal inputted immediately after the switching of the operation mode from the second mode to the first mode.

2. The device of claim 1, wherein the synchronization controller comprises:
a display timing generator configured to generate a third synchronization signal comprising pulses in synchronization with the first synchronization signal in the first mode, and also comprising pulses having the first cycle even when the operation mode is switched from the first mode to the second mode; and
a synchronization mask controller configured to generate the second synchronization signal by masking at least one pulse of the third synchronization signal generated immediately after the switching of the operation mode from the second mode to the first mode.

3. The device of claim 2, wherein a first command is inputted and then the pulses of the first synchronization signal is inputted when the operation mode is switched from the second mode to the first mode, and
the synchronization mask controller is configured to generate the second synchronization signal by masking at least one pulse of the third synchronization signal following the first command.

4. The device of claim 1, wherein the selector is configured to switch a selection from the second image signal to the first image signal in synchronization with the pulse of the second synchronization signal which the synchronization controller generates after a period of time equal to or longer than the first cycle after the switching of the operation mode from the second mode to the first mode.

5. The device of claim 1, wherein the writing controller is configured to compress the first image signal and write the compressed image signal to the frame memory, and
the reading controller is configured to expand the read second image signal.

6. The device of claim 1 further comprising a command interpreter configured to interpret inputted commands,
wherein the commands includes:
a first command indicative of switching the operation mode from the first mode to the second mode; and
a second command indicative of switching the operation mode from the second mode to the first mode.

7. An image display device operable by switching an operation mode among a first mode and a second mode,
wherein in the first mode, a first synchronization signal and a first image signal are inputted, the first synchronization signal comprising pulses having a first cycle, the first image signal being composed of a plurality of frames switching in synchronization with the pulses of the first synchronization signal, and
in the second mode, an input of the first synchronization signal and the first image signal is stopped and a second image signal written to a frame memory is read,
the image processing device comprises:
a synchronization controller configured to generate a second synchronization signal based on the first synchronization signal, the synchronization controller generating pulses of the second synchronization signal, when the operation mode is switched from the second mode to the first mode, after a period of time equal to or longer than the first cycle has elapsed from the switching;
a writing controller configured to write the first image signal to the frame memory;
a reading controller configured to read the first image signal written to the frame memory as the second image signal in synchronization with the pulses of the second synchronization signal;
a selector configured to select the second image signal in the second mode and to select the first image signal after at least second frame of the first image signal inputted immediately after the switching of the operation mode from the second mode to the first mode; and
a display configured to display an image according to the image signal selected by the selector.

8. The device of claim 7, wherein the synchronization controller is configured to generate the pulses of the second synchronization signal, when the operation mode is switched from the second mode to the first mode, after a first period of time which is equal to or longer than the first cycle has elapsed from the switching, and
the display is configured to hold the displayed image during at least the first period of time.

9. The device of claim 7, wherein the display is configured to display a moving image in the first mode and a still image in the second mode.

10. The device of claim 7, wherein the synchronization controller comprises:
a display timing generator configured to generate a third synchronization signal comprising pulses in synchronization with the first synchronization signal in the first mode, and also comprising pulses having the first cycle even when the operation mode is switched from the first mode to the second mode; and
a synchronization mask controller configured to generate the second synchronization signal by masking at least one pulse of the third synchronization signal generated immediately after the switching of the operation mode from the second mode to the first mode.

11. The device of claim 10, wherein a first command is inputted and then the pulses of the first synchronization signal is inputted when the operation mode is switched from the second mode to the first mode, and
the synchronization mask controller is configured to generate the second synchronization signal by masking at least one pulse of the third synchronization signal following the first command.

12. The device of claim 7, wherein the selector is configured to switch a selection from the second image signal to the first image signal in synchronization with the pulse of the second synchronization signal which the synchronization controller generates after a period of time equal to or longer than the first cycle after the switching of the operation mode from the second mode to the first mode.

13. The device of claim 7, wherein the writing controller is configured to compress the first image signal and write the compressed image signal to the frame memory, and
the reading controller is configured to expand the read second image signal.

14. The device of claim 7 further comprising a command interpreter configured to interpret inputted commands,
wherein the commands includes:
a first command indicative of switching the operation mode from the first mode to the second mode; and
a second command indicative of switching the operation mode from the second mode to the first mode.

15. An image processing method operable by switching an operation mode among a first mode and a second mode,
wherein in the first mode, a first synchronization signal and a first image signal are inputted, the first synchronization signal comprising pulses having a first cycle, the first image signal being composed of a plurality of frames switching in synchronization with the pulses of the first synchronization signal, and
in the second mode, an input of the first synchronization signal and the first image signal is stopped and a second image signal written to a frame memory is read,
the image processing method comprises:
generating a second synchronization signal based on the first synchronization signal, pulses of the second synchronization signal being generated, when the operation mode is switched from the second mode to the first mode, after a period of time equal to or longer than the first cycle has elapsed from the switching;
writing the first image signal to the frame memory;
reading the first image signal written to the frame memory as the second image signal in synchronization with the pulses of the second synchronization signal; and
selecting the second image signal in the second mode and selecting the first image signal after at least second frame of the first image signal inputted immediately after the switching of the operation mode from the second mode to the first mode.

16. The method of claim 15, wherein generating the second synchronization signal comprises:
generating a third synchronization signal comprising pulses in synchronization with the first synchronization signal in the first mode, and also comprising pulses having the first cycle even when the operation mode is switched from the first mode to the second mode; and
generating the second synchronization signal by masking at least one pulse of the third synchronization signal generated immediately after the switching of the operation mode from the second mode to the first mode.

17. The method of claim 16, wherein a first command is inputted and then the pulses of the first synchronization signal is inputted when the operation mode is switched from the second mode to the first mode, and
upon masking at least one pulse of the third synchronization signal, at least one pulse of the third synchronization signal following the first command is masked to generate the second synchronization signal.

18. The method of claim 15, wherein upon selecting, a selection from the second image signal to the first image signal is switched in synchronization with the pulse of the second synchronization signal generated after a period of time equal to or longer than the first cycle after the switching of the operation mode from the second mode to the first mode.

19. The method of claim 15, wherein upon writing the first image signal, the first image signal is compressed and the compressed image signal is written to the frame memory, and
upon reading the first image as the second image, the read second image is expanded.

20. The method of claim 15 further comprising interpreting inputted commands,
wherein the commands includes:
a first command indicative of switching the operation mode from the first mode to the second mode; and
a second command indicative of switching the operation mode from the second mode to the first mode.
